(19) United States
(12) Patent Application Publication
(10) Pub. No.: US 2015/0044344 A1
(43) Pub. Date: Feb. 12, 2015

(54) METHOD AND APPARATUS FOR USING A BLENDER WITH NOISE DAMPING ELEMENTS

(71) Applicant: Tribest Corporation, Anaheim, CA (US)

(72) Inventor: William Wooram Choi, Los Angeles, CA (US)

(73) Assignee: Tribest Corporation, Anaheim, CA (US)

(21) Appl. No.: 13/961,836

(22) Filed: Aug. 7, 2013

(51) Int. Cl. A47J 43/07; A47J 43/046

(52) U.S. Cl. CPC A47J 43/0716; A47J 43/046; A47J 43/0727
USPC 426/519; 241/100

(57) ABSTRACT

Described herein is a blender with noise damping elements. In one embodiment, the device may include a base unit having a motor coupled to a drive mechanism. The device may include a food container including an outer shell removably attached, at a bottom portion of the outer shell, to the drive mechanism at a first ring. The food container may include an inner shell removably attached, at a bottom portion of the inner shell, to the drive mechanism at a second ring that is smaller than the first ring. The food container may include a gap between the outer and inner shells. The device may include a top cover removably attached to a top end of the food container.

### BACKGROUND

1. Field

The present disclosure relates to kitchen appliances, and more particularly to food blenders.

2. Background

Blenders may be used in the preparation of a meal or a single food item. A blender provides a convenient tool for mixing, chopping, mincing, cutting, slicing, etc. various food items or other materials. To mix the food items a blender usually includes a motor and drive assembly connected to a blade or cutting element. Operation of the motor and drive assembly, however, creates vibrations and noises. In a setting where many blenders may be used at the same time, such as in a retail setting, the noise may be significant and create distractions for employees and customers. In a smaller or confined space, even a single blender can generate significant noise levels during use. Accordingly, there remains a need for a blender that is quieter to operate.

### SUMMARY

The following presents a simplified summary of one or more embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments in a simplified form as a prelude to the more detailed description that is presented later.

In accordance with one or more aspects of the embodiments described herein, there is provided a mixing device or blender assembly with noise damping. For example the device may include a base unit having a motor coupled to a drive mechanism. The device may include a food container including an outer shell removably attached, at a bottom portion of the outer shell, to the drive mechanism at a first ring. The food container may include an inner shell removably attached, at a bottom portion of the inner shell, to the drive mechanism at a second ring that is smaller than the first ring. The food container may include a gap between the outer and inner shells. The device may include a top cover removably attached to a top end of the food container.

In accordance with one or more aspects of the embodiments described herein, there is provided a method for using a blender having a motorized base unit and a food container. The method may include coupling the food container to the base unit by rotating at least one portion of the food container into a threaded portion of the base unit. The food container may include an outer shell and an inner shell separated by a gap. The method may include adding at least one food ingredient into the food container. The method may include coupling a top cover to a top end of the food container. The method may include activating the motorized base unit to blend the at least one food ingredient.

In accordance with one or more aspects of the embodiments described herein, there is provided a mixing device. For example, the device may include a base unit having a motor coupled to a drive mechanism, the drive mechanism coupled to at least one cutting blade. The device may include a blending jug including an outer shell extending from an outer bottom portion to an outer top portion, the outer shell being removably attached via the outer bottom portion to the drive mechanism. The device may include an inner shell contained within the outer shell, the inner shell extending from an inner bottom portion to an inner top portion, the inner shell being removably attached via the inner bottom portion to the drive mechanism. The blending jug may include a gap between the outer and inner shells.

In accordance with one or more aspects of the embodiments described herein, there is provided a mixing device. For example, the device may include a base unit having a motor coupled to a drive mechanism, the drive mechanism coupled to at least one cutting blade. The device may include a blending jug including a top circular loop section at a top end of the blending jug. The blending jug may include a bottom circular loop section at a bottom end of the blending jug. The blending jug may include an outer shell extending from an outer portion of the top circular loop section to an outer portion of the bottom circular loop section, the outer shell being removably attached via an outer bottom portion to the drive mechanism. The blending jug may include an inner shell contained within the outer shell, the inner shell extending from an inner portion of the top circular loop section to an inner bottom portion of the bottom circular loop section, the inner shell being removably attached via an inner bottom portion to the drive mechanism. The jug may include a space defined by an interior between the top circular section, bottom circular section, outer shell, and inner shell.

To the accomplishment of the foregoing and related ends, the one or more embodiments include the features hereinafter fully described and particularly pointed out in the claims. The following description and the annexed drawings set forth in detail certain illustrative aspects of the one or more embodiments. These aspects are indicative, however, of but a few of the various ways in which the principles of various embodiments may be employed and the described embodiments are intended to include all such aspects and their equivalents.

### BRIEF DESCRIPTION OF THE DRAWINGS

FIG. 1 is a perspective view of an example embodiment of a noised damped blender.

FIG. 2 is an exploded perspective view of the example embodiment of the blender.

FIG. 3 illustrates a coupling mechanism for the blender using threading on the inner shell and threading on the base unit.

FIGS. 4A-B are cut-away perspective views of jars using one-piece construction.

FIG. 5 is a perspective view of an exemplary noise damped blender using the jar illustrated in FIG. 4A.

FIGS. 6A-B is a cut-away perspective view of the blender coupling to the jar illustrated in FIGS. 4A-B.

### DETAILED DESCRIPTION

Various aspects are now described with reference to the drawings. In the following description, for purposes of explanation, numerous specific details are set forth in order to provide a thorough understanding of one or more aspects. It may be evident, however, that the various aspects may be practiced without these specific details. In other instances, well-known structures and devices are shown in block diagram form in order to facilitate describing these aspects.

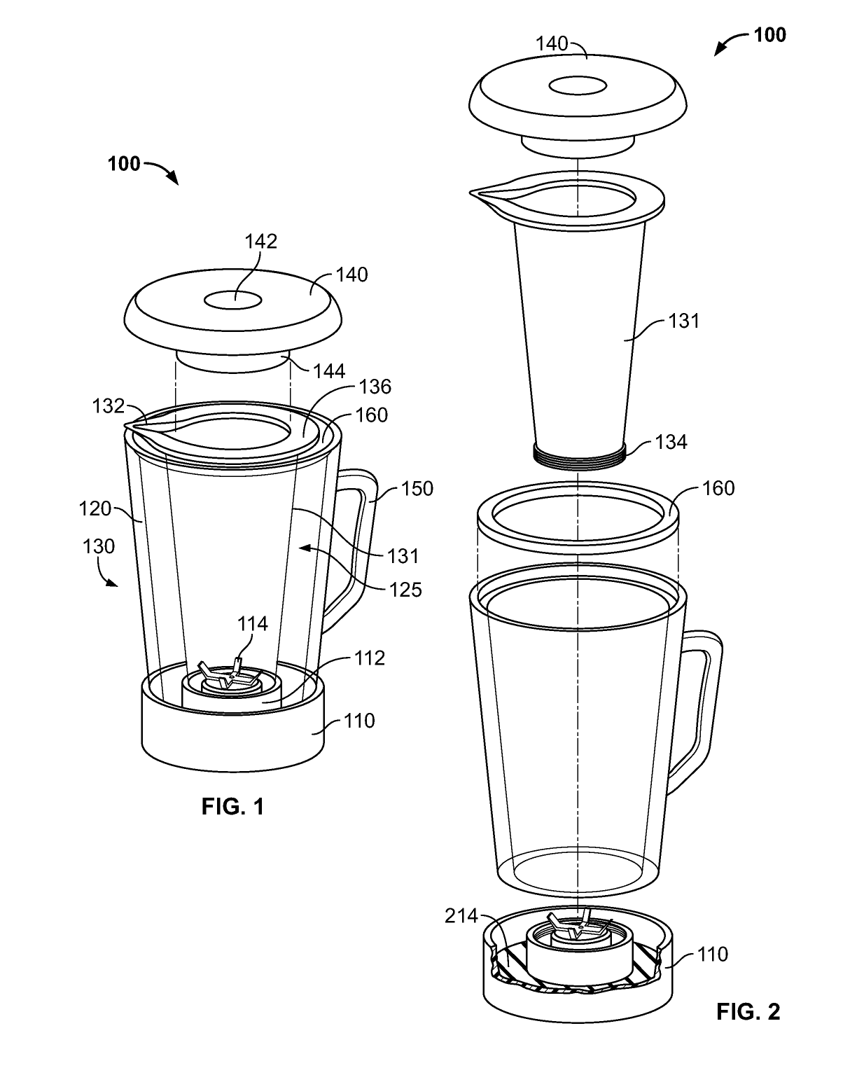

In accordance with aspects of the subject of this disclosure, FIG. 1 shows a perspective view of an example embodiment of a noise damped blender 100. The blender 100 may be configured to isolate noise and/or vibrations, e.g., from the base unit 110, by using a jar 130 with double-walled construction and damping elements. The jar may be referred to as a blending container, pitcher, jug, or the like. Vibrations are reduced by the use of the damping elements, and therefore, less noise may emanate from the blender 100. An advantage to using the double-walled construction for the jar 130 may include heat insulation for food items in the jar 130. The food items in the jar 130 may remain cold or hot while the outer surface of the jar 130 may be closer to the ambient temperature. For example, when hot food items are added to the jar, the double-walled construction may provide heat insulation so that the outer shell 120 or handle 150 does not burn a user touching the outer surfaces.

The blender 100 may be referred to as a food mixer, processor, or the like. The blender 100 may include a base unit 110 that includes a motor and drive mechanism 112. The motor and the drive mechanism 112 may be coupled to each other to form a single unit. The motor may include or be coupled to a power supply source, such as, for example, an alternating current (AC) power source and/or batteries. The blender 100 may also include the jar 130. The jar 130 may take the form of various shapes or configurations, in addition to the shape shown in the example of FIG. 1. The blender 100 may include a top cover 140 to prevent food items from spilling out of the jar 130. The top cover 130 may be made of a material, e.g., rubber or other elastic material, which reduces noise and/or vibrations coming from the blender 100. To prevent the top cover 140 from fall off the jar 130, the top cover 140 may include a protrusion 144 on the bottom surface for attaching to the jar. For example, the protrusion 144 may secure the top cover 140 to the jar 130 by friction. In one aspect, the top cover 140 may include an opening 142 of a defined size or diameter. The opening 142 may be included in the middle of the top cover 140 for use with a kitchen utensil. In another aspect, the top cover may lack any opening on the surface.

One or more ingredients may be added into the jar 130 via the opening defined by the opening at the upper portion. The lower portion may be situated by a rotatable blade assembly 114 or cutting portion that includes one or more rotatable blade, cutting blades, cutters, etc. The rotatable blade assembly 114 may engage with the drive mechanism 112 of the base unit 110. When activated, the motor of the base unit 110 may cause the drive mechanism to rotate, thereby causing the blade assembly 114 to rotate and cut up the ingredient(s) at or near the lower portion of the jar 130.

In one embodiment, the blender 100 may be configured to isolate noise from the drive mechanism 112. For example, the drive mechanism may be separate or isolated from the rest of the base unit 110 by a damping element (now shown). Features of the jar 130 may provide sound and vibration damping. The jar 130 may be configured as a double-walled hollow cylinder with an opening at the lower portion and an opening at the upper portion. A gap 125, e.g., an air gap, may separate the two walls (or containers, cylinders, tubes, etc.) of the jar 130. The gap 125 may isolate noise and insulate the contents of the jar 130 from heat outside of the jar 130. In the example of FIG. 1, the jar 130 may include an inner shell 131 and the outer shell 120. The inner shell 131 and outer shell 120 may be concentric or substantially concentric having a same or substantially similar sloping angle so that the gap 125 is a constant width from the top to the bottom between the two shells 131, 120. The outer shell 120 may extend from an outer bottom portion to an outer top portion of the jar 130. The outer shell 120 may be removable and attachable via the outer bottom portion of the drive mechanism 112. The inner shell 131 may be contained within the outer shell 120 with the inner shell extending from an inner bottom portion to an inner top portion of the jar 130. The inner shell 131 may be removable and attachable via the inner bottom portion to the drive mechanism 112.

The inner shell 131 may include a spout 132 for pouring out the food items, e.g., after mixing. A handle 150 for convenient handling of the blender 100 may be attached to a side of the outer shell 120 on a side, e.g., opposite of the spout 132.

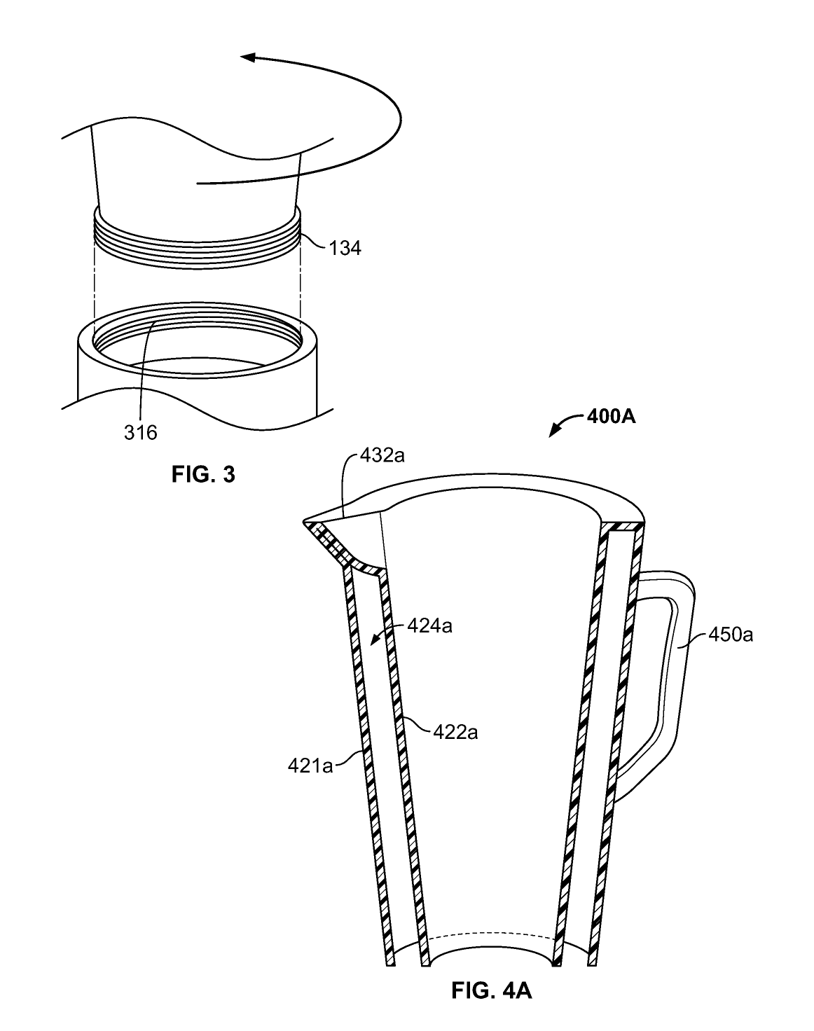

FIG. 2 is an exploded perspective view of the example embodiment of the blender 100. FIG. 2 illustrates coupling of the elements of the blender 100. For example, the jar 130 may be coupled to the base unit 110 at a surface 214 of the base unit 110. The surface 214 may include a damping material for isolating noise and/or vibrations that may be transmitted to the jar 130. The jar 130, including the inner shell 131 and outer shell 120, may be coupled to the surface 214 when the outer shell 131 is threaded into the base unit 110 at the surface 214. A damping ring 160 may be inserted between the inner shell 131 and outer shell 120 to dampen vibrations between the two shells 131, 120. The inner shell 131 may include a brim or flat collar 136 that applies downward pressure against the damping ring 160 onto the outer shell 120 to secure the outer shell 120 to the base unit 110. The top cover 140 may be secured to the jug 130 after the jug 130 is coupled to the base unit 110.

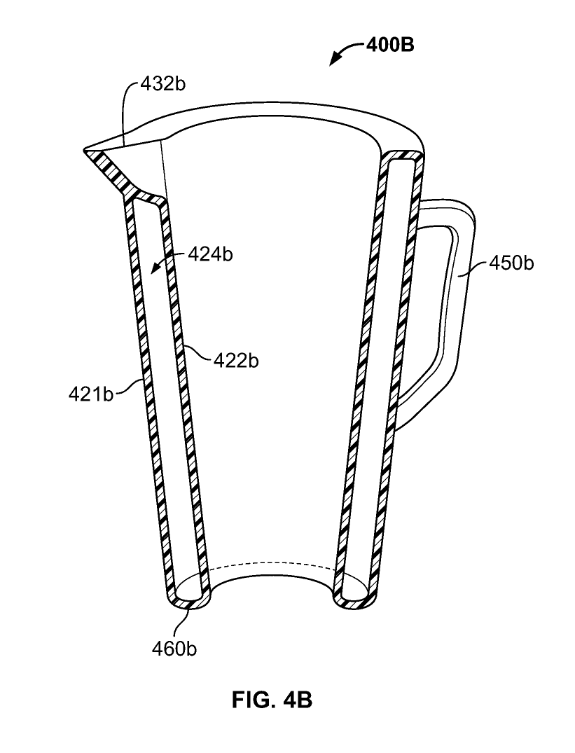

In one example, a user may assemble the blender 100 for mixing food items. First, the base unit 110 is placed on a surface. Next, the jar 130 is coupled to the base unit 110. In one aspect, the outer shell 120 is place over the base unit 110, the damping ring 160 is placed over the outer shell 120, and then the inner shell 131 is placed over the damping ring 160. The jar 130 assembly may then be coupled to the base unit 110 using a threading mechanism 134 (see FIG. 3 below). For example, the threads 134 on the inner shell 131 may mate to threads on the base unit 110. The user may rotate the inner shell 131 into the base unit 110. Food ingredients may be added to the jar through the opening at the top of the jar 130. The top cover 140 may be attached to the jar 130 at the inner shell 131. After the top cover 140 is attached, the blender 100 may be operated by activating the motorized base unit 110 to blend the food ingredients. After mixing, the food ingredients may be poured out through the spout 132.

FIG. 3 illustrates a coupling mechanism for blender 100 using threading on the inner shell 131 and threading on the base unit 110. In the embodiment illustrated in FIG. 3, the base unit 110 may include a threaded portion 316 on an inside surface of the base unit 110. The inner shell 131 may include a threaded portion 134 on an outside surface of the inner shell 131. In one example, the jar 130 may be coupled to the base unit 110 by rotating (e.g., in a counterclockwise direction) the jar 130 into the base unit 110. For example, a user of the blender may place the inner shell 131 by the base unit 110 and match the threading between the two pieces. The user may then spin the inner shell 131 (e.g., in a counterclockwise direction) into the base unit 110. One skilled in the art will readily recognize that the coupling mechanism of the jar 130 to the base unit 110 is not limited to the embodiment shown in FIG. 3. For example, in addition to or in alternative to threads on the inner shell 120, threading may be included on the outer shell 131. In another example, the blender may use other coupling mechanisms, such as snap-lock mechanisms, latches, etc.

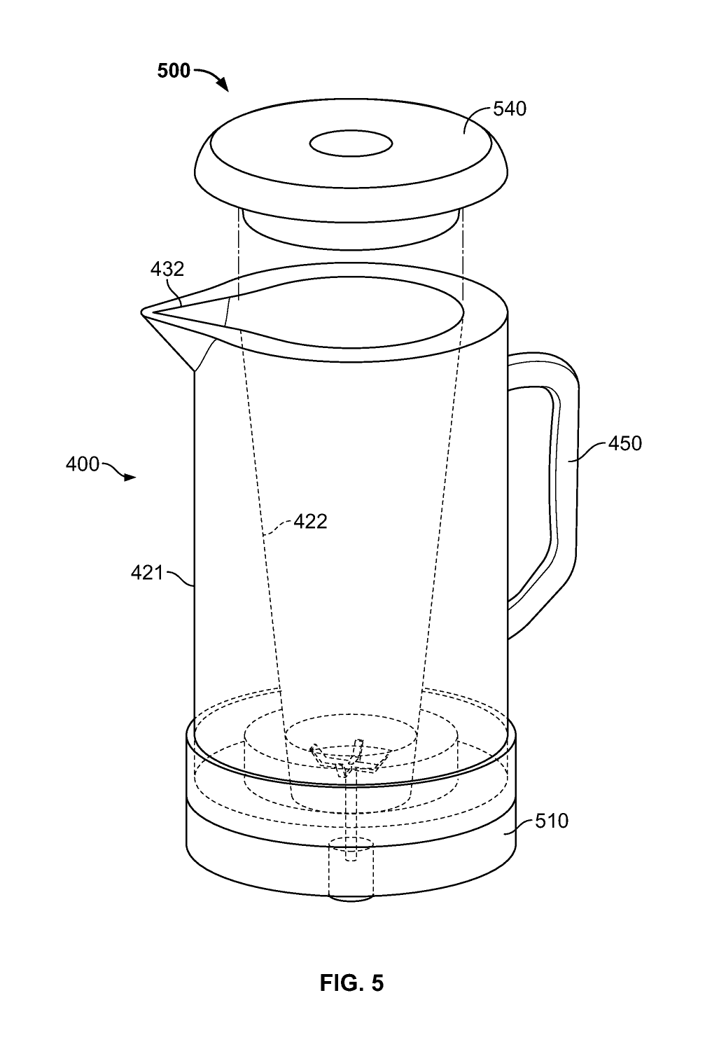

FIG. 4A is a cut-away perspective view of a jar 400A using one-piece construction. The one-piece construction for the jar 400A may provide additional advantages over the jar 130 illustrated in FIG. 1. For example, the one-piece construction may reduce the number of pieces for assembling the blender. A damping ring 160 may not be needed to couple the outer shell 421a and inner shell 422a of the jar 400A. The jar 400A may be interchangeable with the jar 130 for coupling to the base unit 110. For example, the jar 400A may include threads (not shown) on the inner shell 422a for coupling to the base unit 110.

The jar 400A may include a gap 424a (e.g., an air gap) for isolating noise and/or vibration. The outer shell 421a and inner shell 422a may be concentric or substantially concentric. Food items may be added to the jar 400A via the top opening 434a. A spout 432a may be formed from the inner shell 422a out to the outer shell 421a. The spout 432a may allow food items to be poured out of the jar, e.g., after mixing. The jar may include a handle 450a for convenient handling of the blender.

FIG. 4B is a cut-away perspective view of a jar 400B using one-piece construction. In the example of FIG. 4B, the jar 400B may include a sealed space 424b. For example, the sealed space 424b may be surrounded on all sides to form an air-tight enclosure for the sealed space 424b. The addition of a bottom loop 460b joined to sides 421b, 422b, may provide the air-tight seal at the bottom. On the top of the jar 400B, the sides 421b, 422b may be joined to the top section that forms a loop. The loop may be circular with a cut out for the spout 432b. The inner shell 422b and outer shell 421a may be joined at a section to form the spout 432b. In one example, the sealed space may be configured as a vacuum, e.g., with air evacuated from the space. The vacuum may provide noise, vibration, and/or heat isolation. In one aspect, the contours around the sealed space 424b may be smooth to provide strength to withstand the pressures of the vacuum. The height, width, volume, etc., of the space 424b may affect the heat and/or sound isolation properties of the jar 400B. As such, the jar 400B may be configured with different sizes, shapes, density, materials, etc.

One skilled in the art will readily recognize the jars 400A-B may take the form of various shapes or configurations, in addition to the shapes shown in the examples of FIGS. 4A-B.

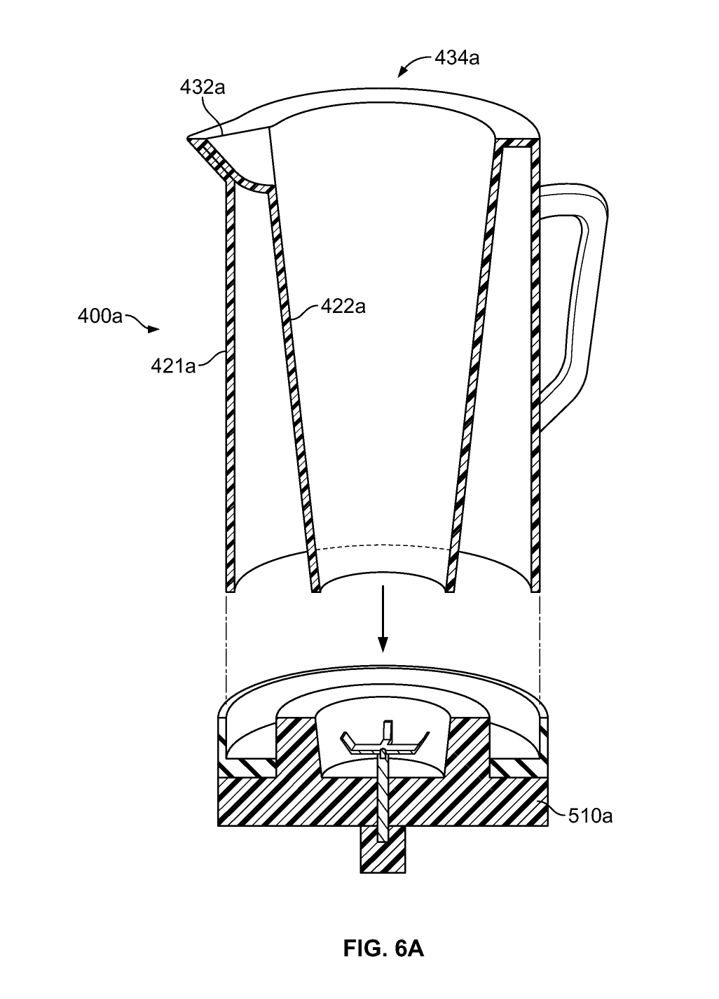

FIG. 5 is a perspective view of an exemplary blender with noise damping. In the example of FIG. 5, the blender 500 may include a base unit 510 configured to couple to the jar 400 illustrated in FIG. 4. For example, the jar 400 may be coupled to the base unit 510 via threads (not shown) on the inner shell 422 and/or outer shell 421 of the jar 400. In another example, the jar 400 may couple to the base unit 510 via other coupling mechanisms.

A top cover 540 may be coupled to the jar 400 at the top portion of the jar 400. The top cover 540 may prevent spilling of the food ingredients during blending. To reduce noise and/or vibrations, the top cover may be made of a damping material such as rubber or other elastic materials.

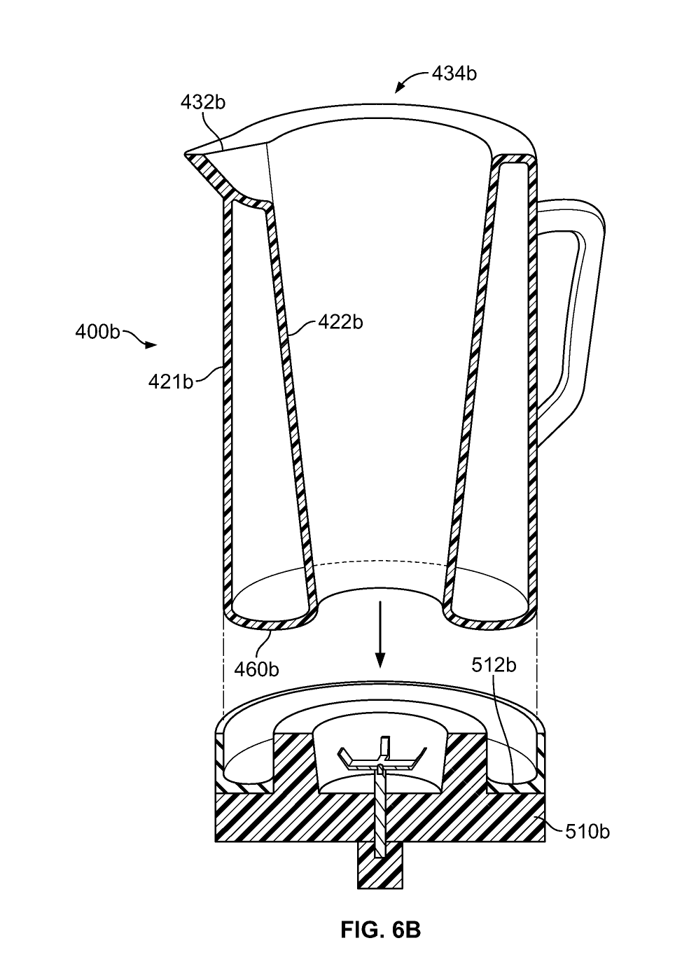

FIG. 6A is a cut-away perspective view of the blender coupling to the jar illustrated in FIG. 4A. In the example of FIG. 6A, the base unit 510a may include a surface designed for coupling to the jar 400A. For example, the surface may include a threaded surface (not shown) on the vertical sections, or the surface may include other locking mechanisms to secure the jar 400A. For example, when the base unit 510a includes the threaded surface, the jar 400A may include complementary threads for coupling to the base unit.

In one example, a user may assemble the blender 500 for mixing food items. First, the base unit 510a is placed on a surface. Next, the jar 400A is coupled to the base unit 510a. The jar 400A assembly may be coupled to the base unit 510a using a threading mechanism (now shown). The user may rotate jar 400A into the base unit 510a. Food ingredients may be added to the jar through the opening at the top of the jar 400A. The top cover 540a may be attached to the jar 400A at the inner shell 422a. After the top cover 540a is attached, the blender 500 may be operated by activating the motorized base unit 510a to blend the food ingredients. After mixing, the food ingredients may be poured out through the spout 432a.

FIG. 6B is a cut-away perspective view of the blender coupling to the jar illustrated in FIG. 4B. In the example of FIG. 6B, the base unit 510b may include a surface designed for coupling to the jar 400B. For example, the surface may include a threaded surface (not shown) on the vertical sections, or the surface may include other locking mechanisms to secure the jar 400B. For example, when the base unit 510b includes the threaded surface, the jar 400B may include complementary threads for coupling to the base unit. Because the jar 400B may have a convex bottom loop 460b, the surface 512b on the base unit 510b may be concave to conform to the jar 400B.

In one example, a user may assemble the blender 500 for mixing food items. First, the base unit 510b is placed on a surface. Next, the jar 400B is coupled to the base unit 510b. The jar 400B assembly may be coupled to the base unit 510b using a threading mechanism (now shown). The user may rotate jar 400B into the base unit 510b. Food ingredients may be added to the jar through the opening at the top of the jar 400B. The top cover 540b may be attached to the jar 400B at the inner shell 422b. After the top cover 540b is attached, the blender 500 may be operated by activating the motorized base unit 510b to blend the food ingredients. After mixing, the food ingredients may be poured out through the spout 432b.

In accordance with one or more aspects of the embodiments described herein, there is provided a methodology for using a blender with noise damping. The method may include coupling the food container to the base unit by rotating at least one portion of the food container into a threaded portion of the base unit, wherein the food container comprises an outer shell and an inner shell separated by a gap. Other coupling mechanisms are possible. The gap may an air gap. The method may include adding at least one food ingredient into the food container. The method may include coupling a top cover to a top end of the food container. The method may include activating the motorized base unit to blend the at least one food ingredient. The method may include coupling a damping element at the top end of the food container prior to coupling the top cover.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A mixing device, comprising:
a base unit having a motor coupled to a drive mechanism;
a food container comprising:
an outer shell removably attached, at a bottom portion of the outer shell, to the drive mechanism at a first ring; and
an inner shell removably attached, at a bottom portion of the inner shell, to the drive mechanism at a second ring that is smaller than the first ring, wherein the food container comprises a gap between the outer and inner shells; and
a top cover removably attached to a top end of the food container.

2. The device of claim 1, wherein the gap comprises an air gap between the outer and inner shells.

3. The device of claim 1, further comprising a first damping element between the drive mechanism and the bottom portion of the outer shell and bottom portion of the inner shell, and a second damping element between the top cover and a top portion of the outer shell and top portion of the inner shell.

4. The device of claim 1, wherein the inner shell is substantially concentric with the outer shell.

5. The device of claim 1, wherein the drive mechanism comprises a threaded section for receiving the inner shell, wherein the inner shell, at the bottom portion, comprises a threaded section for mating to the threaded section of the drive mechanism.

6. The device of claim 1, wherein the outer shell is permanently connected to the inner shell.

7. A method for using a mixing device having a motorized base unit and a food container, the method comprising:
coupling the food container to the base unit by rotating at least one portion of the food container into a threaded portion of the base unit, wherein the food container comprises an outer shell and an inner shell separated by a gap;
adding at least one food ingredient into the food container;
coupling a top cover to a top end of the food container; and
activating the motorized base unit to blend the at least one food ingredient.

8. The method of claim 7, wherein the gap comprises an air gap between the outer and inner shells.

9. The method of claim 7, further comprising coupling a damping element to the top end of the food container prior to coupling the top cover.

10. A mixing device, comprising:
a base unit having a motor coupled to a drive mechanism, the drive mechanism coupled to at least one cutting blade; and
a blending jug comprising:
an outer shell extending from an outer bottom portion to an outer top portion, the outer shell being removably attached via the outer bottom portion to the drive mechanism; and
an inner shell contained within the outer shell, the inner shell extending from an inner bottom portion to an inner top portion, the inner shell being removably attached via the inner bottom portion to the drive mechanism,
wherein the blending jug comprises a gap between the outer and inner shells.

11. The device of claim 10, wherein the outer shell tapers inward from the outer top portion to the outer bottom portion, such that the outer bottom portion comprises a smaller circumference than the outer top portion.

12. The device of claim 11, wherein the inner shell tapers inward from the inner top portion to the inner bottom portion, such that the inner bottom portion comprises a smaller circumference than the inner top portion.

13. The device of claim 10, wherein the gap comprises an air gap between the outer and inner shells.

14. The device of claim 10, further comprising:
a top cover removably attached to a top end of the blending jug;
a first damping element between the drive mechanism and the outer bottom portion of the outer shell and inner bottom portion of the inner shell, and a second damping element between the top cover and the outer top portion of the outer shell and inner top portion of the inner shell.

15. The device of claim 10, wherein the drive mechanism comprises a threaded section for receiving the inner shell, wherein the inner shell, at the inner bottom portion, comprises a threaded section for mating to the threaded section of the drive mechanism.

16. The device of claim 10, wherein the outer shell is permanently connected to the inner shell.

17. A mixing device, comprising:
a base unit having a motor coupled to a drive mechanism, the drive mechanism coupled to at least one cutting blade; and
a blending jug comprising:
a top circular loop section at a top end of the blending jug;
a bottom circular loop section at a bottom end of the blending jug;
an outer shell extending from an outer portion of the top circular loop section to an outer portion of the bottom circular loop section, the outer shell being removably attached via an outer bottom portion to the drive mechanism; and
an inner shell contained within the outer shell, the inner shell extending from an inner portion of the top circular loop section to an inner bottom portion of the bottom circular loop section, the inner shell being removably attached via an inner bottom portion to the drive mechanism,
wherein the jug comprises a space defined by an interior between the top circular section, bottom circular section, outer shell, and inner shell.

18. The device of claim 17, wherein the space comprises an air-tight gap comprising a vacuum.

19. The device of claim 18, wherein the jug comprising the vacuum is configured to isolate noise or heat based on a size, shape, or density of the top circular section, bottom circular section, outer shell, or inner shell.

20. The device of claim 17, wherein the drive mechanism comprises a threaded section for receiving the inner shell, wherein the inner shell, at the bottom portion, comprises a threaded section for mating to the threaded section of the drive mechanism.
